(19) United States
(12) Patent Application Publication
(10) Pub. No.: US 2007/0187325 A1
(43) Pub. Date: Aug. 16, 2007

(54) Method of preparing a cosmetic composition, and an apparatus and a refill for preparing such a composition

(75) Inventors: Roland De La Mettrie, Vesinet (FR); Jean-Francois Grollier, Paris (FR); Jean Cotteret, Verneuil Sur Seine (FR)

Correspondence Address: OLIFF & BERRIDGE, PLC, P.O. BOX 19928, ALEXANDRIA, VA, 22320, US

(73) Assignee: L'OREAL, PARIS (FR)

(21) Appl. No.: 11/698,198

(22) Filed: Jan. 26, 2007

Related U.S. Application Data
(60) Provisional application No. 60/773,649, filed on Feb. 16, 2006.

(30) Foreign Application Priority Data
Jan. 27, 2006 (FR) 06 50306

(51) Int. Cl. B01D 11/04

(52) U.S. Cl. 210/634; 206/581; 210/748

(57) ABSTRACT

A method of preparing a cosmetic composition includes inserting a refill having an enclosure containing a plurality of substances into an extractor apparatus and subjecting the plurality of substances to fluid injection conditions and/or to external action. The extractor apparatus is able to inject at least one fluid into the enclosure. The method allows at least one of the substances to be extracted in differentiated manner.

### CROSS REFERENCE TO RELATED APPLICATIONS

This non provisional application claims the benefit of French Application No. 06 50306 filed on Jan. 27, 2006 and U.S. Provisional Application No. 60/773,649 filed on Feb. 16, 2006, the entire disclosures of which are herein incorporated by reference.

The present invention relates to preparing compositions for applying to keratinous materials by injecting at least one fluid into an enclosure including at least one substance suitable for being extracted from the enclosure by the flow of fluid therethrough.

### BACKGROUND

The following European patent applications: EP 1 563 827-A2, EP 1 566 164-A1, EP 1 563 885-A1, EP 1 559 400-A1, EP 1 559 398-A1, EP 1 563 826-A1, EP 1 559 414-A1, EP 1 563 826-A1, EP 1 559 401-A1, EP 1 559 392-A1, EP 1 559 396-A1, and EP 1 556 163-A1, all disclose methods of preparing a cosmetic composition by percolating a fluid.

Application WO 00/56629 discloses a cartridge for an apparatus for extraction by percolation.

European patent application EP 1 559 396 discloses a method of preparing a cosmetic composition by percolating a fluid such as water, for example, through an enclosure defined by a blister similar to that used in espresso type coffee machines.

### SUMMARY

There exists the need to make it easier to prepare personalized cosmetic compositions, e.g., presenting one or more characteristics selected by the user.

There also exists the need to facilitate the preparation of a large number of compositions for application on keratinous materials from a single extractor apparatus for extracting substances by injecting fluid.

In one of its aspects amongst others, the invention provides a method of preparing a cosmetic composition, the method comprising:

inserting at least one refill having at least one enclosure containing a plurality of substances into an extractor apparatus enabling at least one fluid to be injected; and

subjecting the plurality of substances to fluid injection conditions and/or to external action selected in such a manner as to cause at least one of the substances to be extracted in a differentiated manner.

The injection condition parameters on which it is possible to act as a function of the composition that it is desired to obtain may comprise, in particular: temperature, pressure, duration of injection, and the nature of the fluid that is injected.

In embodiments of the invention, it is possible with a single refill to prepare at least two compositions presenting characteristics that are different, for example different colors or different dyeing powers, thus making it easier to obtain a cosmetic composition that is personalized.

In embodiments of the invention, the enclosure includes at least two substances having different extraction temperatures.

By way of example, the enclosure may include at least first and second substances having solubility factors at a first temperature that are sufficiently different for injection of the fluid at that temperature to cause the first substance to be extracted in the majority, and solubility factors at a second temperature that are closer together, such that injecting the fluid at said temperature causes the first and second substances to be extracted in relative proportions that are different from those observed at the first temperature.

In embodiments of the invention, the refill includes two substances capable of passing into solution substantially from respective injection temperatures T₁ and T₂, or even three substances corresponding to respective temperatures T₁, T₂, and T₃.

In such embodiments, for an injection temperature greater than that T₁, but less than T₂, only a selected substance or substances passes into solution.

For a temperature lying in the range T₂ and T₃, more, e.g., two substances pass into solution, and for a temperature greater than T₃, all of the substances may pass into solution.

Substances contained in the enclosure can thus be extracted in differentiated manner as a function of the temperature of the injected fluid, the temperature being selected as a function of the substance(s) that it is desired to extract.

Substances contained in the enclosure may also be extracted in any manner that is differentiated as a function of the pressure of the injected fluid, which pressure can be modified to favor extraction of one substance rather than another, for example.

The enclosure may include two substances, at least one of which is encapsulated in a shell that is sensitive to temperature and/or pressure, or is contained in a polymer matrix that is sensitive to temperature and/or pressure.

The enclosure may also include first and second substances having different extraction rates under the same injection conditions. By selecting the duration over which the fluid is injected into the enclosure, it is possible to extract a first substance together with more or less of a second substance.

At least one external action can also be exerted on the refill prior to or simultaneously with the injection of fluid into the enclosure, this action having an influence on the extraction of at least one substance contained in the enclosure.

By way of example, the above-mentioned action may comprise exposing the enclosure to electromagnetic radiation or to ultrasound vibration, which can have an effect for example on a barrier between two substances present in the enclosure where the injection is taking place, on a shell encapsulating one of the substances, or on a polymer matrix containing one of the substances.

By way of example, the exposure to radiation and/or to vibration can cause heating or some other physical phenomenon to take place, serving to break the barrier or shell, or to burst the polymer matrix.

When the external action is prior to or simultaneous with the injection of the fluid, it may be exerted by the extractor apparatus or otherwise, for example using some other apparatus.

Differentiated extraction may also be achieved by using different fluids or mixtures of different fluids, such as mixtures of water and of a solvent (e.g., propylene glycol or glycerine) with varying concentrations of solvent(s). These different fluids may have different dissolving effects on substances contained in the enclosure.

Composition preparation conditions can depend on control systems that can be arranged firstly to receive at least one item of information relating to a characteristic of the composition to be produced, and secondly to respond to said item of information to determine injection conditions and/or whether to use external action.

The above-mentioned characteristic of the composition may be its color or its dying power.

Thus, in embodiments of the invention, the enclosure contains at least two colored substances capable of being extracted in differentiated manner, with fluid injection conditions being selected as a function of the tint to be obtained.

In another of its aspects, embodiments of the invention also provide a refill for an apparatus for preparing a cosmetic composition by injecting a fluid, the refill comprising:

at least one enclosure; and

at least two cosmetic substances contained in the enclosure, these substances being extractable in differentiated manner for at least two different conditions relating to injection of fluid into the enclosure and/or relating to the environment of the enclosure.

Substances contained in the enclosure may be extracted in differentiated manner as a function of the temperature of the fluid and/or of its pressure, for example.

While the refill is in use, the environment of the enclosure may also be selected so as to exert an action on the extraction of substances, for example by the presence of an electric field or of an electromagnetic field or of ultrasound vibration, or of some other stimulus.

The enclosure may contain at least two colored substances having different colors and capable of being extracted in differentiated manner.

The enclosure may include at least one polymer having a change-of-state temperature lying in a range of injection temperatures that can be reached by the extractor apparatus. By way of example, the polymer may form a shell that encapsulates the substance or that is present in the form of a matrix containing the substance.

When the temperature of the fluid injected into the enclosure is lower than the change-of-state temperature of the polymer, the substance(s) held captive in the shell or the matrix is not extracted therefrom, or is extracted to a lesser extent than the other substance(s) contained in the enclosure, but outside the shell or the matrix.

The enclosure may also include at least one substance that is encapsulated in at least one blister that is sensitive to pressure or that is contained in porous particles.

By way of example, the enclosure may include two substances contained in particles having different porosities, such that it is possible to perform differentiated extraction as a function of the pressure at which the fluid is injected.

At least one of the substances contained in the enclosure may be in powder form.

Substances contained in the enclosure may be mixed together uniformly. At least two substances contained in the enclosure may alternatively be disposed in at least two distinct regions of the enclosure.

The enclosure may include at least one barrier separating at least two different substances, by way of example the barrier may present at least two different states of permeability to the fluid, which states depend on the conditions under which the fluid is injected or on the environment of the enclosure.

The barrier may be thermosensitive and may pass from a state in which it is substantially impermeable to the fluid to a state in which it is permeable to the fluid, with this taking place from a temperature that lies within a range of injection temperatures of the apparatus.

In another of its aspects, embodiments of the invention also provide an apparatus for preparing a composition for application to keratinous materials by injecting a fluid into at least one enclosure including at least one cosmetic substance, the apparatus including a selector system enabling at least one condition for injection of fluid into the enclosure to be selected from a plurality of conditions.

By way of example, the selector system may make it possible to select one injection temperature from a plurality of injection temperatures.

By way of example, the selector system may make it possible to select an injection pressure and/or an injection duration from a plurality of pressures and/or durations.

The selector system may include a control member on which the user can act manually, e.g., for the purpose of modifying the duration and/or the temperature and/or the pressure of injection.

The selector system may be arranged to receive at least one item of information relating to a characteristic of the composition that is to be obtained, for example its color, and it may include a processor making it possible automatically to determine at least one fluid injection condition as a function of said item of information.

The selector system may be arranged to receive at least one item of information relating to an individual to be treated with the composition, for example relating to skin color or hair color, and it may include a processor arranged to determine at least one fluid injection condition as a function of said item of information.

The selector system may be arranged to receive at least one item of information relating to the nature of at least one substance contained in the enclosure, for example the quantities that are extracted as a function of various values for an injection parameter, and it may include a processor enabling at least one injection condition to be determined as a function of said item of information.

The apparatus may thus include a system for reading at least one item of information carried by a refill defining the enclosure.

By way of example, this may be constituted by an optical reader system, and the refill may include at least one item of information that is readable by the reader system, e.g., a bar code.

For example, the item may provide information about the properties of the solution-that will result from extraction as a function of injection conditions, e.g., a tint as a function of the injection temperature and/or pressure, and/or as a function of the duration of injection.

This can enable the apparatus to determine precisely the injection conditions that will enable a desired result to be obtained.

Information that appears on the refill may be communicated to the extractor apparatus or to a computer system exchanging information therewith in some other way, for example it may be input via a keyboard or an electronic chip.

The extractor apparatus may include an injector arranged to pass through a wall of a refill defining the enclosure.

The apparatus may include a plurality of injectors enabling the fluid(s) to be injected into one enclosure or into a plurality of enclosures.

### BRIEF DESCRIPTION OF THE DRAWINGS

Various details of the present invention may be better understood by reading the following detailed description of non-limiting embodiments, and on examining the accompanying drawings, in which:

FIG. 1 is a diagrammatic perspective view of an example of a refill;

FIG. 2 is a cross-sectional view of the FIG. 1 refill;

FIG. 3 is a diagrammatic perspective view of an example of an extractor apparatus;

FIG. 4 is a simplified diagrammatic view of an example of a feed circuit for the extractor apparatus of FIG. 3;

FIG. 5 is a fragmentary cross-sectional view of the refill in place in the apparatus;

FIG. 6 is a view analogous to FIG. 3, showing a variant embodiment of the extractor apparatus;

FIG. 7 is a fragmentary and diagrammatic view of a variant feed circuit; and

FIGS. 8 and 9 are views analogous to FIG. 1 showing variant embodiments of the refill and showing the corresponding positioning of the injectors.

### DETAILED DESCRIPTION OF EMBODIMENTS

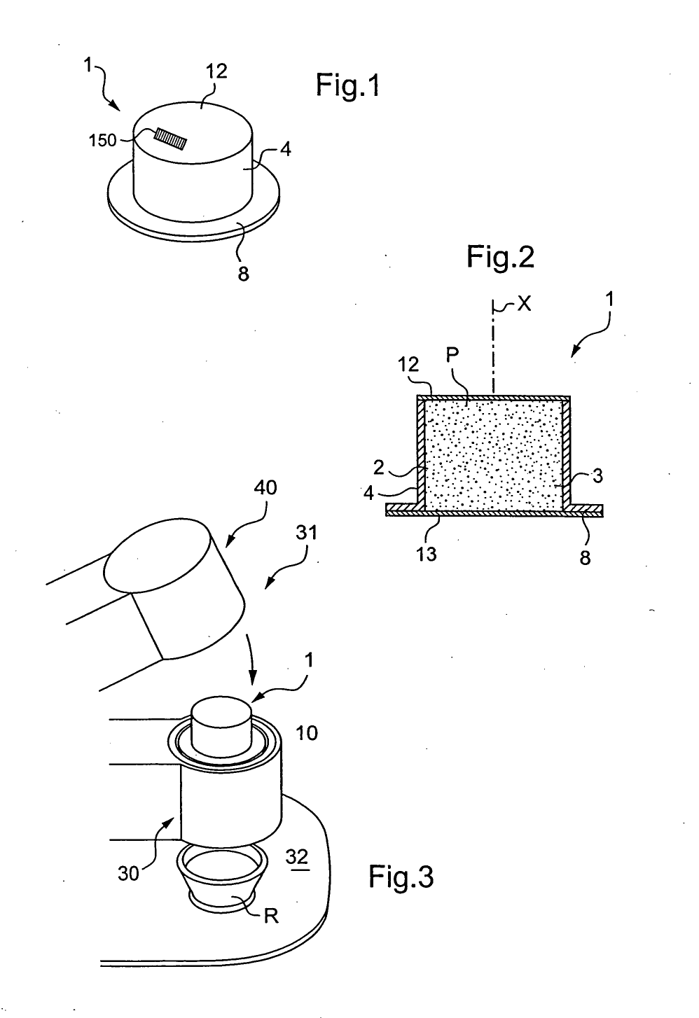

FIGS. 1 and 2 show a refill 1 containing at least two cosmetic substances P₁ and P₂ (represented collectively by P in the drawings) suitable for differentiated extraction. The word “refill” is used because a user could refill (replenish) the user's supply of the substance P by purchasing one or more refills 1 when desired (for example, when the user's supply of substance P is depleted). The refills 1 are not themselves necessarily refilled with substance P (that is, they are not necessarily re-used), although in embodiments they could be refilled with substance P.

The refill 1 comprises a tubular body 4 and first and second walls 12 and 13 defining an enclosure 2 containing the substances.

In the example shown, the first wall 12 is made as a single piece together with the body 4, e.g., by molding plastics material or by stamping sheet material including a metal layer, for example.

By way of example, the second wall 13 is a film that can include at least one layer of a metal, and that is fastened, e.g., heat sealed, on a flange 8 that is made integrally with the body 4.

In order to manufacture the refill 1, the person skilled in the art can easily refer to refills that exist for preparing beverages of the “espresso” type by percolation.

The substances P₁ and P₂ can be extracted by causing a fluid to flow through the enclosure 2, the concentration of each substance in the solution leaving the enclosure being a function of the conditions of injection, for example, as described below.

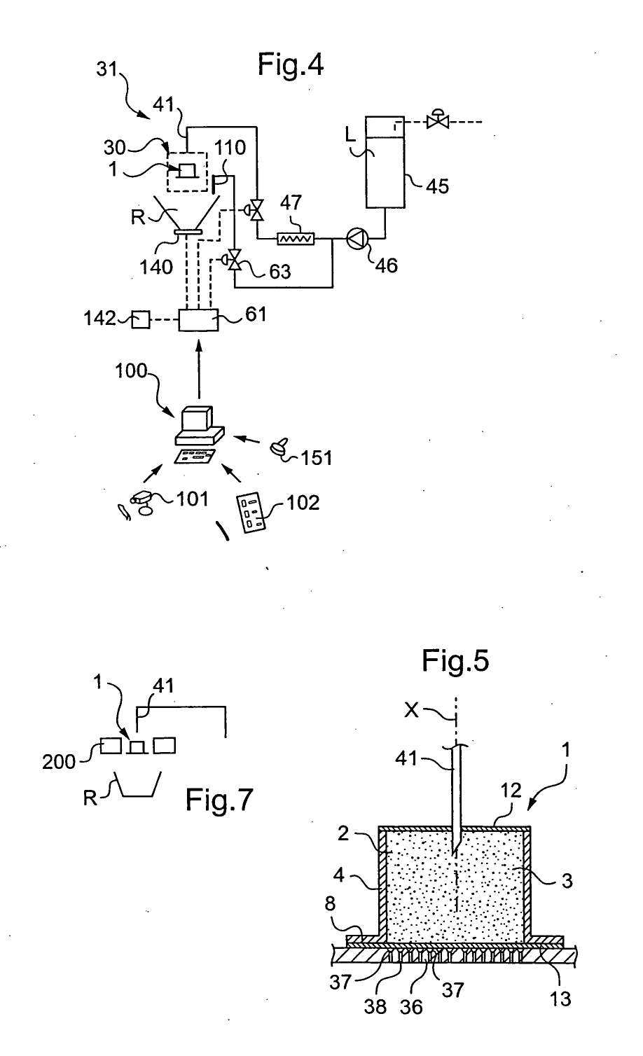

In order to use the refill 1 of FIG. 1, the user may place it on a support system 30 of an extractor apparatus 31 that also includes an injector system 40, as shown in FIGS. 3 and 4.

In the example shown, the extractor apparatus 31 includes a gap 32 under the support system 30 for receiving a receptacle R suitable for collecting a solution coming from percolation of a fluid through the enclosure 2.

As shown in FIG. 5, the support system 30 can include a grid 36 provided with portions in relief 37 against which the second wall 13 can be pressed under the pressure of the injected fluid.

The second wall 13 is arranged to be perforated, during injection, by the portions in relief 37 of the grid, under the effect of the pressure existing in the enclosure, thereby enabling the injected fluid to flow through the-channels 38 in the grid 36 towards the receptacle R.

The second wall 13 may advantageously be opened in such a manner as substantially to retain inside the enclosure in question the bodies that have not dissolved.

The receptacle R may be wide enough to collect the solutions flowing from the enclosure, given its position.

The injector system 40 includes at least one injector 41 capable of passing through the first wall 12 and of penetrating into the selected enclosure.

The extractor apparatus 31 may include sealing means (not shown) making it possible, where necessary, to guarantee that the injector 41 penetrates in leaktight manner into the selected enclosure.

By way of example, these sealing means may comprise at least one sealing gasket that bears against the outside of the refill, at least during injection.

As shown diagrammatically in FIG. 4, the extractor apparatus 31 may include an extractor fluid feed circuit having: at least one tank 45 for containing the liquid L that is to be injected; a pump 46; and a heater member 47 serving to raise the liquid L to the desired temperature, and where appropriate to generate steam. This can contribute to generating the desired injection pressure.

In the example described, the fluid injection pressure (relative pressure) can, for example, reach at least 3 bars (3×10⁵ Pa) or even at least 10 bars, and the injection temperature lies in the range 20° C. to at least 80° C., for example, and particular in the range 20° C. to 110° C. In particular, the temperature of the fluid may be sufficient for the fluid to present both liquid and gaseous phases while it is being injected into the enclosure.

The tank 45 of the extractor apparatus may be filled manually or automatically, being connected to a water pipe, e.g., via a solenoid valve.

Where appropriate, the tank 45 may be removable so as to make it easier to fill manually.

The heater member 47 may comprise an electrical resistor element.

A control system 61 may comprise a processor suitable for acting on the heater member 47 to set the temperature of the fluid at a predefined value.

Optionally, the control system 61.imay also act on the pump 46 or on a bypass circuit (not shown), so as to set the injection pressure at a predefined value.

The extractor apparatus 31 may also include a level sensor that is useful for detecting when it is necessary to refill the tank 45 or to enable the receptacle R to be filled with a predefined total quantity of composition, for example.

The extractor apparatus may include an output 110 enabling the liquid L to be dispensed into the receptacle R without contact with the substance(s) contained in the refill.

The output 110 may be fed by using a solenoid valve 63 or any other means for controlling the quantity of fluid that is dispensed, such as a pump, for example.

The solenoid valve 63 can be controlled by the control system 61, e.g., so as to have a final volume of composition in the receptacle that corresponds to a predefined value.

When the duration of the injection is a condition of injection on which action is taken in order to vary the contents of the various substances in the composition, it may be useful to be able to deliver the fluid without passing through the enclosure in order to have a predefined volume of composition.

The extractor apparatus can include a weight sensor 140 that is placed under the receptacle R, and that is useful for determining the quantity of fluid that has been delivered to said receptacle. The weight sensor 140 can be connected to the control system 61.

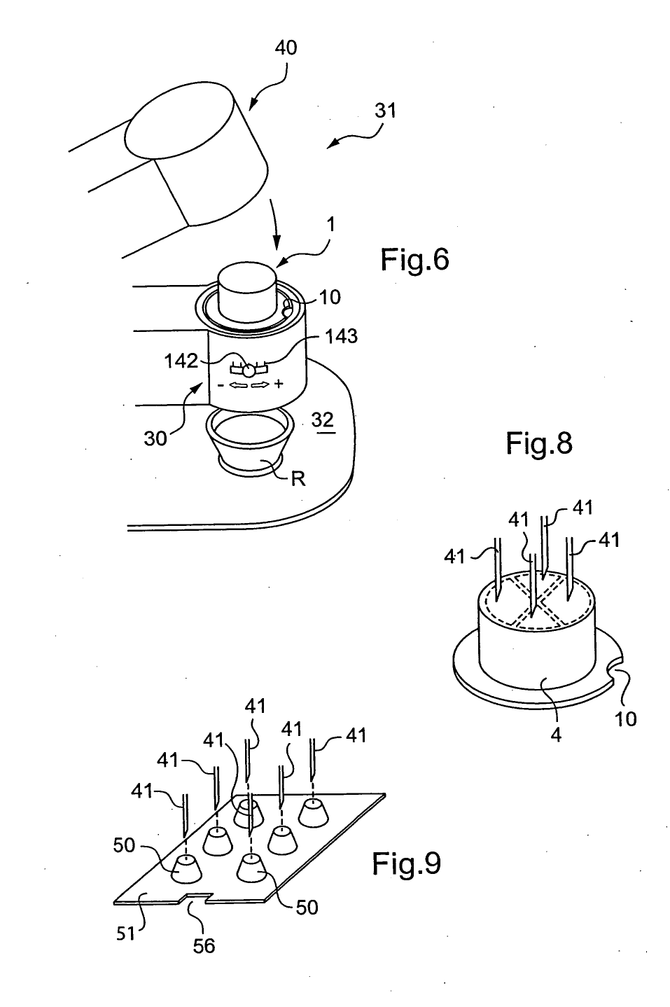

As shown in FIG. 6, the extractor apparatus can include a control member 142 making it possible to modify at least one condition of fluid injection into the enclosure. By way of example, the control member 142 includes a slider for displacing as a function of the injection temperature desired. The extractor apparatus can include graduations 143 making it possible to set the temperature.

FIG. 4 shows the possibility of the feed circuit exchanging data with a computer system 100, e.g., comprising at least one microcomputer, a personal digital assistant (PDA), a terminal connected to a network, or a mobile telephone, or even that is integrated in the extractor apparatus and constitutes at least in part the control system 61 thereof, for example.

The computer system 100 may be associated with a data acquisition system, e.g., comprising a camera 101 or any other device for analyzing keratinous materials, e.g., for analyzing the color of the skin or of the hair.

The computer system 100 may also be associated with a color chart or with a hair color chart 102 or with some other evaluation tool, e.g., a questionnaire.

The computer system 100 may be arranged in such a manner as to enable a user to select at least one characteristic of the cosmetic composition that is to be prepared. By way of example, this characteristic may be color.

The computer system 100 may be used to enable the user to select a desired tint, and the computer system 100 may be arranged to send data to the control system 61 enabling it to select the fluid-injection conditions in such a manner as to obtain a composition having the desired properties.

The computer system 100 may also be arranged to read at least one item of data associated with the refill 1, which item may comprise an identifier.

For example, the refill 1 may carry a bar code 150, and the computer system may have a reader 151 adapted to read the bar code 150. By way of example, the code may contain at least one item of information relating to the substances present in the enclosure. By way of example, such information may enable the extractor apparatus or the computer system associated with the extractor system to keep track of variation in the concentration of each substance extracted as a function of the quantity of fluid injected and as a function of the injection conditions. This can make it easier to select injection conditions and to calculate the quantities of fluid to be delivered into the enclosure in order to obtain the desired composition.

Where appropriate, the person skilled in the art can easily refer to the extractor apparatuses used for preparing beverages of the “espresso” type, and the feed circuits thereof can be reproduced, at least in part.

By way of example, such apparatuses are disclosed in the following publications: AT 168 405, U.S. Pat. No. 2,688,911, DE 3 243 870, IT 1 265 636, and WO 2004/006 740-A2.

As shown in FIG. 7, the extractor apparatus may include a generator 200 enabling action to be exerted on the content of the enclosure.

By way of example, the generator 200 is a generator of electromagnetic radiation, e.g., microwaves, or it is an ultrasound generator.

The generator may be actuated manually or under the control of the control means 61.

This actuation may be prior to injecting the fluid, or it may be simultaneous therewith, and it may have an effect on the extraction of at least one substance by the fluid.

As shown in FIGS. 8 and 9, the extractor apparatus can include a plurality of injectors 41 that are respectively associated with a plurality of enclosures.

Injection may be performed into a selected enclosure by causing the injector to penetrate into the corresponding enclosure, e.g., by moving the injector and/or the capsule, where this movement may be caused, the example, by the user acting on at least one of the injector system and the support system. This movement may also be the result of drive from a pneumatic or a hydraulic motor, e.g., with assistance from the pressure of the fluid.

The quantity of fluid injected into the selected enclosure(s) may be predefined, or, for example, selected as a function of the concentration desired for the or each compound extracted.

In the example of FIG. 8, the refill 1 is in the form of a cartridge, the enclosures being formed by compartments thereof that are separated by partitions that are made by being molded as a single piece together with the body of the refill, for example.

The flange 8 may be provided with keying means 10, e.g., in the form of a recessed or projecting portion in relief, e.g., a notch.

Alternatively, if the body 4 is made without keying means 10, it could be made to be of a shape that is not circularly symmetrical, so as to allow it to be positioned in the associated extractor apparatus in one way only.

The volume of each of the enclosures is preferably less than or equal to 25 cubic centimeters (cm³) or even 10 cm³, e.g., in the range of 1 cm³ to 5 cm³.

If necessary, the user can perform several injections in succession in different enclosures and can collect the solutions that result from percolation in a single receptacle, in order to mix them.

The refill 1 may be in a form other than that of a cartridge, and for example as shown in FIG. 9, it may have enclosures defined by capsules 50 carried by a support element 51, e.g., in the form of a plate.

By way of example, the capsules 50 may have a first wall that is formed by stamping or thermoforming a sheet material, e.g., aluminum or a laminate including aluminum. As stamped or thermoformed, this wall may define the support element 51 around the capsules 50.

The capsules 50 may be closed by a second wall, e.g., constituted by a film that is heat sealed on the support element 51.

The support element 51 may include a keying feature 56, e.g., the form of a notch.

Where appropriate, the support element 51 and the capsules 50 may be made separately. For example, the support element 51 can be made in the form of a plate with holes, and the capsules can be secured in the holes, e.g., as a function of the substances that it is desired to associate within a single refill. The capsules may be fastened in the holes of the support element in optionally releasable manner. Where appropriate, releasable fastening can enable the user to replace used capsules with new capsules. By way of example the releasable fastening may be performed by friction and/or by snap-fastening.

In the example of FIG. 9, the capsules 50 are disposed in rows. In variants not shown, the support element is annular in shape, or it is in the form of a strip.

The refill may also be given further shapes other than those shown, the example in the form of a small tray, a sachet, etc. Capsules or sachets containing different substances may be contained in a single package.

The enclosures may be filled at the time of manufacture. In a variant, the enclosures may be filled as a function of requests made by a consumer, for example.

Different compartments in a single refill may be made separately and then assembled together.

During manufacture, the enclosures may also be in a deployed configuration, and this configuration can be modified during manufacture and/or in use.

Fluid may flow in a selected enclosure either vertically or otherwise.

In the examples shown, injection into a selected enclosure takes place via a single injector, however in a variant injection may take place via a plurality of injectors.

As mentioned above, the enclosure in which the injection takes place may include at least one material that is sensitive to pressure, and that contains one of the substances.

By way of example, the enclosure may include at least one substance contained in a porous material, and another substance contained in another porous material, or that is free, or that is contained in some other way.

As examples of materials that are sensitive to pressure and suitable for being present in the enclosure so as to enable extraction to be performed in different manners as a function of the conditions under which the fluid is injected, and in particular as a function of its pressure, mention can be made of the following:

microparticles of porous silica, e.g., having a mean size in the range of 0.5 micrometers (μm) to 20 μm, and a specific surface area in the range of 50 square meters per gram (m²/g) to 1000 m²/g, in particular in the range of 150 m²/g to 800 m²/g, as disclosed in application EP 1 421 931; as examples of porous silica microbeads, mention can be made of the following commercial products: Silica Beads SB 150 from the supplier Myoshi; Sunsphere H-51 from the supplier Asahi Glass; Sunsil 130 from the supplier Sunjin; Spherica P-1500 from the supplier Ikeda Corporation; and Sylosphere from the supplier Fuji Silysia;

the porous particles disclosed in European patent application EP 1 493 433; such particles may present a mean diameter less than or equal to 10 μm and a specific surface area greater than or equal to 1 m²/g, for example, in the range of 2.5 m²/g to 1000 m²/g; such porous particles can be derived from organic porous particles selected from particles of nylon 6, nylon 6-6, nylon 12, and nylon 6-12, and particles of polymethyl methacrylate; the porous particles may also be derived from inorganic porous particles, for example, particles selected from particles of silica-alumina, of hydroxyapatite, of titanium dioxide, and mixtures thereof;

porous particles as disclosed in French patent application FR 2 856 921, e.g., having a mean size in the range of 1 μm to 25 μm and selected for example from particles of acrylic polymer;

polymers that under hydrolysis enable delayed release of a compound, as disclosed in international application WO 97/25366, suitable for being prepared by a condensation reaction between polyols, preferably diols, and acetal dicetenes. These polymers may be in the form of matrices capable of retaining a substance so long as conditions for degradation thereof are not satisfied; and

porous particles as disclosed in European patent application EP 0 306 236, suitable for being formed of cross-linked polymers, of diameter in the range of 10 μm to 40 μm and having a specific surface area in the range of 20 m²/g to 200 m²/g; by way of example, these particles are constituted by a copolymer of styrene and of divinyl benzene, or of methyl methacrylate and of ethylene glycol dimethacrylate, or of 4-vinylpyridine and of ethylene glycol dimethacrylate.

The enclosure may also include at least one compound that is sensitive to heat, e.g., selected from:

thermofusible crystalline polymers having a crystalline melting point as measured by differential enthalpy analysis lying in the range 30° C. to 80° C., as disclosed in European patent application EP 1 174 114 A1, for example, thermofusible crystalline polymers constituted by:

i) 85% to 98% by weight of hydrophobic moieties derived from α,β-ethylene monomers with an n-alkyl side chain in the range C₁₂₋₅₀, preferably in the range C₁₄₋₂₄, forming crystalline homopolymers; and

ii) 2% to 15% by weight of hydrophilic moieties derived from C₃₋₆ α,β-unsaturated monocarboxylic acids, C₄₋₆ unsaturated di-carboxylic acids, short-chain esters and amides of such monocarboxylic or di-carboxylic acids, hydroxyethyl methacrylate, and vinylpyrrolidone; the thermofusible crystalline polymer may be a random copolymer containing about 10% by weight of moieties derived from an acrylic acid and about 90% by weight of moieties derived from octadecyl methacrylate;

semi-crystalline polymers having a melting point greater than or equal to 30° C. as disclosed in European patent application EP 1 543 816 A1, for example, those having a melting point in the range of 30° C. to 80° C., e.g., those presenting a weight mean molecular mass greater than or equal to 1000, e.g., in the range of 5,000 to 100,000, better in the range of 10,000 to 500,000; such semi-crystalline polymers may comprise:

i) a polymer backbone and ii) at least one crystallizable side chain and/or at least one crystallizable organic sequence forming part of the backbone of the crystalline polymer; such semi-crystalline polymers may be selected from sequenced copolymers and having at least one crystallizable sequence and at least one amorphous sequence, homopolymers, and copolymers having at least one crystallizable side chain per repetition, moiety, and mixtures thereof; the crystallizable sequence may be different in kind from the amorphous sequence. These semi-crystalline polymers may have a crystallizable organic chain and/or a crystallizable sequence representing at least 30% and preferably 40% of the total weight of the polymer; these semi-crystalline polymers may be selected from:
sequenced copolymers of controlled crystallization polyolefins;
polyester-type polycondensates;
homo- or co-polymers carrying at least one crystallizable side chain; and
mixtures thereof;

polymers having a mean molecular mass in the range of 5,000 to 500,000 and containing at least one polyorganosiloxane group and at least two groups capable of establishing hydrogen bonds, selected from the group consisting of esters, amides, sufonamides, carbamates, thiocarbamate, urea, urethane, thio-urea, oxamido, gluanamido, and biguanido groups, and combinations thereof, and at least one crystalline silicone compound, as disclosed in US patent application US 2004/0120912 A1;

the temperature-sensitive polyether polyurethanes obtained from a diisocyanate compound and polyoxyalkylene glycol, as disclosed in European patent application EP 0 692 506 A2; and

semi-crystalline polymers that are solid at ambient temperature having a melting temperature below 70° C. and comprising a polymer backbone and at least one organic crystallizable side chain and/or at least one organic crystallizable sequence forming part of said polymer backbone, as disclosed in French patent application FR 2 863 889.

### EXAMPLE

Two identical coloring refills are made containing an anhydrous composition in the enclosure, the composition having the following formulation (concentrations by weight):
red coloring agent (2Nβ hydroxy ethylamino 5 aminonitrobenzene) 20% coated in a thermofusible polymer having a melting point of 80° C.:
yellow coloring agent (2N methyl amino 4βγ dihydroxy propyloxy 30% nitrobenzene) coated in thermofusible polymer having a melting point lying in the range 85° C. to 90° C.:
maltodextrene: 50%

Water at a temperature of 80° C. and at a pressure of 15 bars is injected into the first refill. 10 mL of composition are recovered suitable for dying human hair having 90% white hair to a red shade.

Water at a temperature of 95° C. and at a pressure of 15 bars is injected into the second refill. 10 mL of composition are recovered suitable for dying human hair having 90% white hair to an orange shade.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

The term “comprising a” should be understood as being synonymous with “comprising at least one”, unless specified to the contrary.

What is claimed is:

1. A method of preparing a cosmetic composition, the method comprising:
inserting at least one enclosure containing a plurality of substances into an extractor apparatus configured to inject at least one fluid into the at least one enclosure; and
subjecting the plurality of substances to fluid injection conditions and/or to external action causing at least one of the substances to be extracted in differentiated manner.

2. A method according to claim 1, in which at least two substances contained in the enclosure are suitable for being extracted in differentiated manner as a function of an injection temperature of the fluid, and in which the temperature of the fluid injected into the enclosure is selected as a function of at least one substance that is to be extracted, and optionally also as a function of a concentration desired for the at least one substance.

3. A method according to claim 1, in which at least two substances contained in the enclosure can be extracted in differentiated manner as a function of a pressure of the fluid, and in which the pressure of the fluid injected into the enclosure is selected as a function of the at least one substance that is to be extracted, and optionally also as a function of a concentration desired for the at least one substance.

4. A method according to claim 1, in which at least one external action is exerted on the enclosure prior to or simultaneously with the injection of the fluid into the enclosure, said action having an influence on the extraction by the fluid of at least one substance contained in the enclosure.

5. A method according to claim 4, the external action being exerted by the extractor apparatus.

6. A method according to claim 4, the action comprising exposing the enclosure to electromagnetic radiation.

7. A method according to claim 4, the action comprising exposing the enclosure to ultrasound.

8. A method according to claim 1, the enclosure including at least two colored substances suitable for being extracted in differentiated manner, in which method the conditions under which the fluid is injected are selected as a function of a tint to be obtained.

9. A method according to claim 4, the enclosure including at least two colored substances capable of being extracted in differentiated manner, in which method the external action is selected as a function of a tint to be obtained.

10. A method according to claim 1, wherein a pressure of the fluid is greater than or equal to 1 bar.

11. A method according to claim 10, the pressure being greater than or equal to 3 bars.

12. A method according to claim 10, the pressure being greater than or equal to 10 bars.

13. A method according to claim 1, in which the at least one substance is collected after extraction in a receptacle.

14. A method according to claim 1, the at least one fluid being water.

15. A package for an extractor apparatus enabling a cosmetic composition to be prepared by injecting a fluid into the package, the package comprising:
at least one enclosure; and
at least two cosmetic substances contained in the enclosure, the substances being extractable in differentiated manner for at least two different conditions of injection of the fluid into the enclosure and/or when a predefined external action is exerted on the enclosure.

16. A package according to claim 15, the enclosure including at least two substances having different extraction temperatures.

17. A package according to claim 16, the enclosure including at least a first substance and a second substance having solubility factors at a first temperature that are sufficiently different for injection of the fluid at said first temperature to cause the first substance to be extracted in the majority, and solubility factors at a second temperature that are closer together, such that injecting the fluid at said second temperature causes the first substance and the second substance to be extracted in relative proportions that are different from those obtained at the first temperature.

18. A package according to claim 15, the at least two cosmetic substances including first and second substances having different colors or leading to different dying effects.

19. A package according to claim 15, the enclosure including at least one substance encapsulated in a material that is sensitive to temperature and/or to pressure.

20. A package according to claim 15, the enclosure including at least one substance contained in a polymer matrix that is sensitive to temperature and/or to pressure.

21. A package according to claim 15, the enclosure including at least one coloring agent incorporated in a porous material.

22. A package according to claim 21, wherein the porous material comprises porous particles.

23. An extractor apparatus for preparing a composition for application to keratinous materials by injecting a fluid into at least one enclosure including at least one cosmetic substance, the apparatus including a selector system enabling at least one condition to be selected from a plurality of conditions for injection of the fluid into the enclosure.

24. An apparatus according to claim 23, the selector system enabling an injection temperature to be selected.

25. An apparatus according to claim 23, the selector system enabling an injection pressure to be selected.

26. An apparatus according to claim 23, the selector system being configured to receive at least one item of information relating to a characteristic of the composition to be obtained, and the apparatus including a processor enabling at least one condition to be determined for injecting the fluid as a function of said item of information.

27. An apparatus according to claim 26, in which the characteristic of the composition is a color or a drying power.

28. An apparatus according to claim 23, the selector system being configured to receive at least one item of information relating to the nature of at least one substance contained in the enclosure, and the apparatus including a processor enabling at least one condition for injecting the fluid to be determined as a function of said item of information.

29. An apparatus according to claim 23, including a reader system for reading at least one item of information carried by a refill defining the enclosure.

30. An apparatus according to claim 23, including a generator of electromagnetic radiation arranged to expose the enclosure to the electromagnetic radiation.

31. An apparatus according to claim 23, including an ultrasound generator arranged to expose the enclosure to ultrasound vibration.

32. An apparatus according to claim 24, the injected fluid being at a pressure of at least 3 bars and at a temperature greater than 80° C.

33. An apparatus according to claim 25, the fluid being in both vapor and liquid phases.

34. An apparatus according to claim 23, the fluid being water.

35. An assembly comprising:
at least one enclosure including two cosmetic substances capable of being extracted in differentiated manner depending on conditions under which fluid is injected into the enclosure; and
an extractor apparatus as defined in claim 23.
